(19) United States
(12) Patent Application Publication
(10) Pub. No.: US 2011/0014921 A1
(43) Pub. Date: Jan. 20, 2011

(54) NETWORK ELEMENT, WIRELESS COMMUNICATION UNIT AND METHOD FOR EMPLOYING MEASUREMENT REPORTS

(76) Inventor: David Neil, Cambridgeshire (GB)

Correspondence Address: FITCH EVEN TABIN & FLANNERY, 120 SOUTH LASALLE STREET, SUITE 1600, CHICAGO, IL, 60603-3406, US

(21) Appl. No.: 12/812,398

(22) PCT Filed: Nov. 27, 2008
(86) PCT No.: PCT/EP08/66300

§ 371 Date: Sep. 9, 2010

(30) Foreign Application Priority Data
Jan. 10, 2008 (GB) 0800362.6

(51) Int. Cl. H04W 36/00

(52) U.S. Cl. 455/444

(57) ABSTRACT

A network element for a cellular communication system comprises a receiver for receiving a message from a wireless communication unit that comprises a measurement report. The network element further comprises signal processing logic, operably coupled to the receiver, for processing the received measurement report and extracting a global cell identifier therefrom.

### FIELD OF THE INVENTION

The field of the invention relates to a cellular communication system, a communication network element, a wireless communication unit and method for employing measurement reports therein. In particular, the field of the invention relates to a network element and method for providing measurement reports in a cellular communication system that comprises femto-cells and macro-cells.

### BACKGROUND OF THE INVENTION

Wireless communication systems, such as the 3^{rd} Generation (3G) of mobile telephone standards and technology, are well known. An example of such 3G standards and technology is the Universal Mobile Telecommunications System (UMTS), developed by the 3^{rd} Generation Partnership Project (3GPP) (www.3gpp.org).

Typically, wireless communication units, or User Equipment (UE) as they are often referred to in 3G parlance, communicate with a Core Network (CN) of the 3G wireless communication system via a Radio Network Subsystem (RNS). A wireless communication system typically comprises a plurality of radio network subsystems, each radio network subsystem comprising one or more cells to which UEs may attach, and thereby connect to the network.

The 3^{rd} generation of wireless communications has been developed for macro-cell mobile phone communications. Such macro cells utilise high power base stations (NodeBs in 3GPP parlance) to communicate with UEs within a relatively large coverage area.

Lower power (and therefore smaller coverage area) femto-cells or pico-cells are a recent development within the field of wireless cellular communication systems. Femto-cells or pico-cells (with the term femto-cells being used hereafter to encompass pico-cells or similar) are effectively communication coverage areas supported by low power base stations (otherwise referred to as Access Points (APs)). These cells are able to be piggy-backed onto the more widely used macro-cellular network and support communications to UEs in a restricted, for example ‘in-building’, environment. Typical applications for such femto-cell APs include, by way of example, residential and commercial (e.g. office) locations, ‘hotspots’, etc, whereby an AP can be connected to a core network via, for example, the Internet using a broadband connection or the like. In this manner, femto-cells can be provided in a simple, scalable deployment in specific in-building locations where, for example, network congestion at the macro-cell level may be problemmatic.

In a femto cell network it is known that there may be a very large number of femto cells compared to the number of macro cells, with femto cells often residing within or overlapping macro cells in the same geographic area.

Thus, the coverage area of a single macro cell will inevitably overlap (and encompass) a coverage area of a large number of femto cells.

In a planned macro cell network, a so-called neighbour cell list is used to identify adjacent cells to each macro cell, to facilitate handover of UE communications between cells. The neighbour cell list is broadcast to roaming UEs via NodeBs to enable the roaming UE to receive and assess the suitability of continuing a communication by transferring the communication to an adjacent (neighbour) cell. The neighbour cell list of the macro cell contains frequency and scrambling code information for all of the cells whose coverage area overlaps with the macro cell, to allow the UE to be able to receive and decode transmissions from the neighbouring cells.

However, a use of such a broadcast neighbour cell list becomes unworkable when applied to a femto cell network, as the standard macro cell neighbour cell list is limited to ‘32’ entries, where the coverage area of the macro cell is likely to overlap a much larger number of femto cells.

Referring now to FIG. 1, a message sequence chart 100 of a known use of a neighbour cell list and measurement reports in a 3GPP macro-cell network is illustrated. In a macro cell network, the neighbour cell list is configured in the radio network controller (RNC) 120. The RNC 120 stores a neighbour cell list for each of the Node-Bs 115 that the RNC 120 controls. The macro cell neighbour cell list is normally configured based on information provided by a cell-planning database (not shown). The cell-planning database can be informed of the geographic location of a Node-B 115 and is able to return a list of other Node-Bs 115 that overlap with the identified Node-B 115. A neighbour cell list for a Node-B 115 (as configured at the RNC 120) is essentially a list of structures; with each structure containing a frequency and scrambling code to be used by the UE to access signals from every neighbour cell 105.

If we assume that an user equipment (UE) 110 is participating in an active call, the UE 110 receives the neighbour cell list in a radio resource control (RRC) system information message 130 from the RNC 120. The UE 110 measures the cells with the specified frequency and scrambling code to identify the best (generally closest) neighbouring macro cells to consider as potential target cells.

The system messages 130, 135 also instruct the UE 110 as to what criteria should be used to trigger the sending of a measurement report (e.g. measuring a signal level and/or signal quality from a neighbouring cell that exceeds a predetermined threshold) 145, and what information should be included in a measurement report. The system messages 130, 135 assign each neighbour cell a temporary identifier (sometimes referred to as an ‘index’) that is used to refer to the cell in the corresponding measurement report 145. The messages 130, 135 do not contain the Global Cell ID of each neighbour cell.

The UE 110 then monitors 140 the specified neighbour cells), identified in RRC measurement control message 135, until one of them meets the specified criteria. Once one of the neighbour cells meets the specified criteria, the UE 110 sends a Measurement Report to the RNC 120. When the UE 110 reports measurements for a cell 145, the UE includes the corresponding cell ‘index’ from the system information message 130 that it receives. The cell ‘index’ is an abstract temporary identifier. The Measurement Report 145 identifies which cell meets the criteria using the cell ‘index’ assigned in the Measurement Control and/or System Information messages.

The RNC 120 takes the temporary identifier from the measurement report and uses this to look up the corresponding Global Cell Identity. Based on the information in the Measurement Report 145, the RNC 120 determines whether to perform handover for the UE 110. If the RNC 120 decides that handover is required it then informs the mobile switching centre (MSC) 125 or SGSN (not shown), in a Radio Access Network Application Protocol (RANAP) message 150 containing the Global Cell Identity of the target cell, that a relocation is required. A cell handover process then occurs.

However, in a femto cell network, given the limited number of available frequencies and scrambling codes, multiple cells need to be assigned the same frequency and scrambling code. Often, all the femto cells in a particular area are assigned frequency and scrambling codes such that adjacent cells have different scrambling codes, in order to minimise interference between femto cells.

Given the large number of femto cells compared to the number of macro cells, it is not possible to ensure that all the femto cells within the coverage area of a macro cell have individual and different frequencies and scrambling codes.

In a combined femto cell-macro cell environment, the macro cell RNC will be unable to determine, from the measurement report received from the UE, which cell (either a femto cell or macro cell) was measured. Notably, this problem does not occur in a standard planned (macro cell) network, as the system planners are able to ensure that the coverage area of each cell only overlaps with a small number of other cells.

Thus, there exists a need for a method and apparatus for employing an improved measurement report in a cellular communication system that combines macro-cell and femto-cells, which aims to address at least some of the shortcomings of past and present techniques.

### SUMMARY OF THE INVENTION

Accordingly, the invention seeks to mitigate, alleviate or eliminate one or more of the abovementioned disadvantages singly or in any combination.

According to a first aspect of the invention, there is provided a network element for a cellular communication system. The network element comprises a receiver for receiving a message that comprises a measurement report from a wireless communication unit. The network element further comprises signal processing logic, operably coupled to the receiver, for processing the received measurement report and extracting a global cell identifier therefrom.

In this manner, the inventive concept provides an improvement to the use of measurement reports, which may be used to facilitate handover between cells in a cellular communication system. Furthermore, when applied in a 3GPP system, the inventive concept does not require new 3GPP messages to be adopted, as it re-uses existing 3GPP messages that are used to set up measurements. In addition, the proposed use of existing 3GPP measurement reports utilises reports that already contain the IDs needed to report the global cell identifier.

In one optional embodiment of the invention, the network element may be a radio network controller arranged to support handover from a macro cell to a femto-cell or pico-cell over a third generation partnership project (3GPP) (or similar) system. In this manner, the inventive concept may be used to allow numerous femto (or pico) cells to co-exist within a macro cell.

In one optional embodiment of the invention, handover may be initiated from a planned cell, e.g. a macro cell, to an unplanned cell, e.g. a femto cell, which is identified by the global cell identifier. The unplanned cell may be one of multiple femto cells that overlap at least one macro cell.

In one optional embodiment of the invention, the signal processing logic of the network element may be further arranged to determine whether the network element has been configured to use the extracted global cell identifier. In this manner, the network element may be able to determine whether to initiate handover based on the extracted global cell identifier.

According to a second aspect of the invention, there is provided a method for employing measurement reports in a cellular communication system. The method comprises receiving a message from a wireless communication unit wherein the message comprises a measurement report. The method further comprises processing the received measurement report and extracting a global cell identifier therefrom.

According to a third aspect of the invention, there is provided a wireless communication system adapted to support an aforementioned network element or adapted to support the aforementioned method steps.

According to a fourth aspect of the invention, there is provided a wireless communication unit for use in a cellular communication system. The wireless communication unit comprises a receiver for receiving a first message from a network element requesting a measurement report of a neighbour cell. The wireless communication unit further comprises signal processing logic, operably coupled to the receiver, for processing a second message received from the neighbour cell, extracting a global cell identifier from the second message and producing a measurement report comprising the extracted global cell identifier. The wireless communication unit further comprises a transmitter for transmitting the measurement report to the network element.

According to a fifth aspect of the invention there is provided a computer-readable storage element. The computer-readable storage element has computer-readable code stored thereon for programming signal processing logic to perform a method for employing measurement reports in a cellular communication system. The computer-readable storage element comprises code for receiving a message from a wireless communication unit that comprises a measurement report of a neighbour cell. The computer-readable storage element further comprises code for processing the received measurement report and extracting a global cell identifier therefrom.

According to a sixth aspect of the invention there is provided a computer-readable storage element having computer-readable code stored thereon for employing measurement reports in a cellular communication system. The computer-readable storage element comprises code for receiving a first message from a network element requesting a measurement report of a neighbour cell. The computer-readable storage element further comprises code for processing a second message received from the neighbour cell, extracting a global cell identifier from the second message from the neighbour cell; producing a measurement report comprising the extracted global cell identifier; and transmitting the measurement report to the network element.

These and other aspects, features and advantages of the invention will be apparent from, and elucidated with reference to, the embodiments described hereinafter.

### BRIEF DESCRIPTION OF THE DRAWINGS

FIG. 1 illustrates a message sequence chart of a known use of neighbour cell list information and measurement reports in a macro-cell 3GPP cellular communication system.

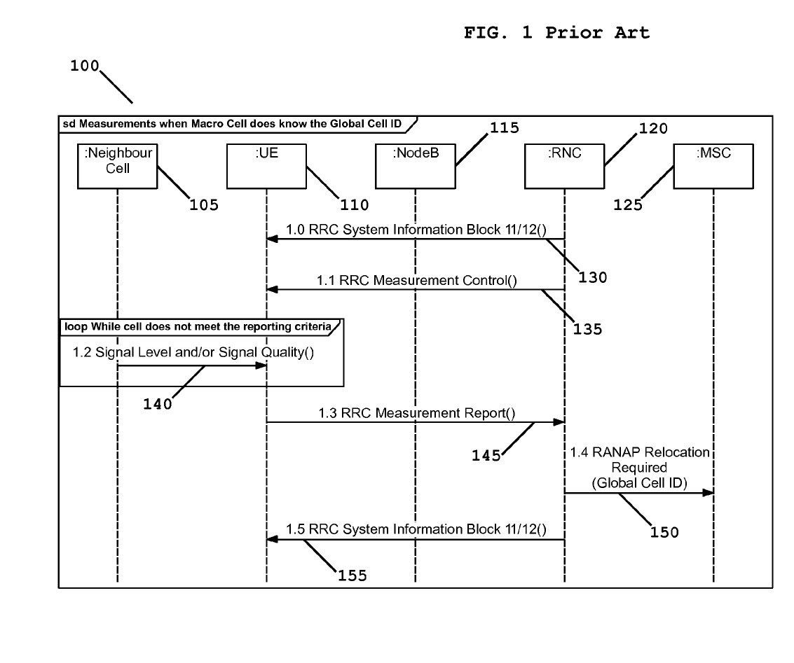

Embodiments of the invention will be described, by way of example only, with reference to the accompanying drawings, in which:

FIG. 2 illustrates an example of a cellular communication system that combines macro-cell and femto-cells, adapted in accordance with embodiments of the invention.

FIG. 3 illustrates a message sequence chart of measurement reports in a cellular communication system that combines macro-cell and femto-cells, in accordance with embodiments of the invention.

FIG. 4 illustrates a typical computing system that may be employed to implement processing functionality in embodiments of the invention.

### DETAILED DESCRIPTION OF EMBODIMENTS OF THE INVENTION

The inventive concept finds particular applicability in a cellular communication system that supports a number of overlapping communication coverage areas, for example a communication system that comprises a combination of femto cells and macro cells. In a femto cell network it is known that there may be a very large number of femto cells per macro cell. Thus, the coverage area of a single macro cell will inevitably overlap a coverage area of a large number of femto cells.

Those skilled in the art, however, will recognize and appreciate that the specifics of this example are merely illustrative of some embodiments and that the teachings set forth herein are applicable in a variety of alternative settings. For example, since the teachings described hereafter do not depend on a particular cellular communication network conforming to any specific standard, it is envisaged that the teachings and inventive concept described herein can be applied to any type of cellular communication network, although a 3^{rd} generation partnership project (3GPP) network is shown in this embodiment. As such, other alternative implementations within cellular communication networks conforming to different standards are contemplated and are within the scope of the various teachings described.

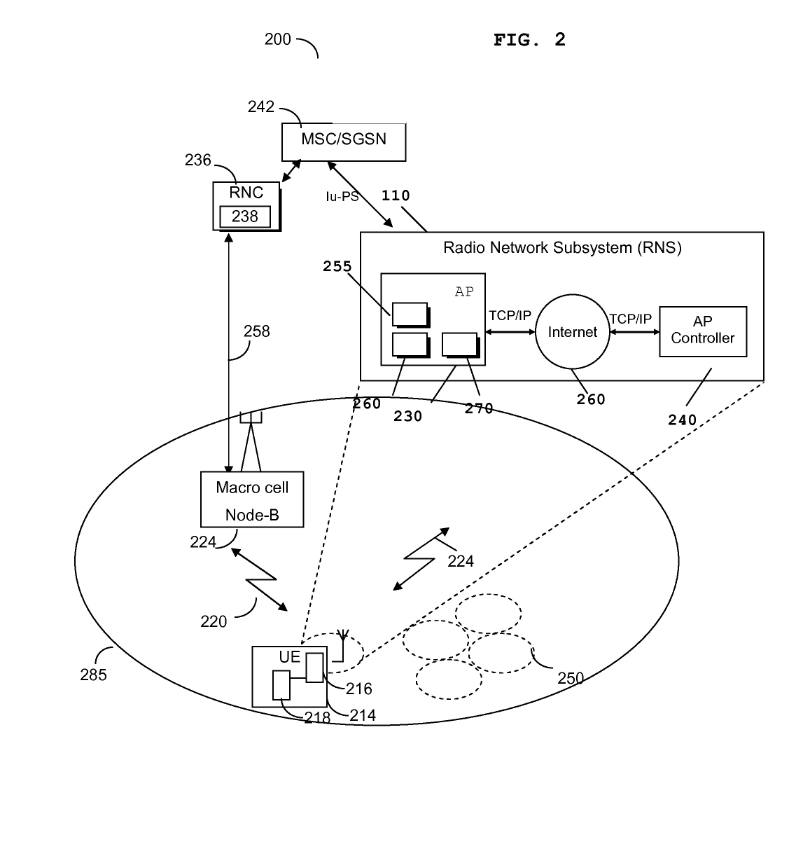

Referring now to the drawings, and in particular FIG. 2, an example of part of a 3GPP network, adapted in accordance with some embodiments of the invention, is illustrated and indicated generally at 200. In FIG. 2, there is illustrated an example of a communication system 200 combining macro cells 285 and femto cells 250 in accordance with one embodiment of the invention. For the embodiment illustrated in FIG. 2, the radio network sub-system (RNS) comprises two distinct architectures to handle the respective macro cell and femto cell communications. In the macro cell scenario, the RNS comprises an RNC 236 having, inter alia, processing logic 238 arranged to generate and process improved measurement reports according to one embodiment of the invention. The RNC 236 is operably coupled to a network element 242, such as a serving GPRS support node (SGSN)/mobile switching centre (MSC), as known.

In a femto cell scenario, an RNS 210 comprises a network element in a form of an Access Point (AP) 230, and a controller in a form of an AP controller 240. As will be appreciated by a skilled artisan, an Access Point (AP) 230 is a communication element that facilitates access to a communication network via a communication cell, such as a femto-cell. One application is that an AP 230 may be purchased by a member of the public and installed in their home. The AP 230 may then be connected to an AP controller 240 over the owner's broadband internet connection 260.

Thus, an AP 230 is a scalable, multi-channel, two-way communication device that may be provided within, say, residential and commercial (e.g. office) locations, ‘hotspots’ etc, to extend or improve upon network coverage within those locations. Although there are no standard criteria for the functional components of an AP, an example of a typical AP for use within a 3GPP system may comprise Node-B functionality and some aspects of radio network controller (RNC) 236 functionality. The AP communicates with UEs, such as UE 214, via a wireless interface (Uu).

The AP controller 240 may be coupled to a core network (CN) 242 via an Iu-PS interface as shown. In this manner, the AP 230 is able to provide voice and data services to a cellular handset, such as UE 214, in a femto cell in contrast to the macro cell, in the same way as a conventional Node-B, but with the deployment simplicity of, for example, a Wireless Local Area Network (WLAN) access point.

In accordance with embodiments of the invention, a cellular communication system that combines macro-cell and femto-cells is configured to allow the macro cell to resolve which femto cell a user equipment (UE) is measuring when it sends a measurement report to the macro cell, and potentially facilitate handover to the femto cell. In this manner, the macro cell is configured to distinguish between prospective cells, for example with regard to a UE handover, using a modification of the existing 3GPP measurement reports.

In a combined femto cell-macro cell environment, the macro cell radio network controller (RNC) would previously have been unable to determine, from a measurement report received from the UE, which cell (either a femto cell or macro cell) was measured by the UE. As there is a limited number of cell identifiers used in a macro-cell only communication system, one mechanism to support an additional plurality of femto cell identifiers could be to combine the femto cell identifiers into a single entry in the macro cell's neighbour cell list. In this manner, the mechanism could be used to ensure that there remained sufficient space in the limited macro cell neighbour cell list to comply with the existing 3GPP standard.

However, an approach to combine the plurality of femto cell identifiers into a single entry within the macro-cell neighbour list would result in a further problem. For example, let us consider when a UE camped on the macro system (in a combined macro-cell/femto-cell environment) measures signals from an identified one of the neighbour cells, the UE reports the measurement results to the macro system's RNC, indexed on the position of the identified neighbour cell in the neighbour cell list. It would then be up to the macro cell RNC to identify the Cell Identity of the reported neighbour cell based on the information contained in the macro cell neighbour list look-up table. This mechanism is possible when a given entry in the neighbour cell list corresponds to a single cell, but would cause problems when each entry in the neighbour cell list corresponds to multiple possible femto cells.

Currently, within the 3GPP standard, an RNC in a macro-cell network may request that a roaming UE reads the global cell identifier from the neighbour cells and to include the global cell identifier information in the measurement reports transmitted to the RNC. However, currently, the 3GPP specifications currently dictate that this feature should be disregarded and that the UEs must ignore this instruction from the RNC (see 3GPP TS 25.331 section 8.6.7.7). Thus, the 3GPP standard currently dictates that the RNC uses the ‘index’ in the received measurement report to identify, from the neighbour cell list configured in the RNC, the neighbour cell being reported.

In accordance with one embodiment of the invention, the UE 214 is modified such that it no longer ignores the request/instruction from the RNC 236. The UE 214 comprises transceiver circuitry 216 to communicate wirelessly 220 with the RNC 236 via the NodeB 224 in the macro cell, or to communicate wirelessly 222 with the AP 230. Furthermore, the UE 214 also comprises signal processing logic 218 operably coupled to the transceiver circuitry 216 and arranged to process the received system information from the RNC 236 and obtain a global cell identifier from any subsequently monitored macro or femto cells. Thereafter, the UE 214 is arranged to include the identified Global Cell Identity together with the abstract index in the measurement report transmitted to the macro cell network via the UE's transceiver circuitry 216.

Thereafter, the signal processing logic 238 of the RNC 236 of the macro-cell network is modified to use the Global Cell Identity reported by the UE 214 instead of using the configured Global Cell Identity as adopted in existing 3GPP systems.

In accordance with one embodiment of the invention, the macro cell neighbour cell list may be configured to mark femto cell entries as ‘unplanned’, and as such these entries are not allocated a configured (abstract ‘index’) Global Cell Identity. Similarly, it is envisaged that the network may be set up such that scrambling codes associated with macro cells are configured with associated global cell identifiers (i.e. ‘planned’ entries. For all ‘unplanned’ entries in the neighbour cell list, the macro cell instructs the UE to measure particular system signals and include the respective Global Cell Identity(ies) in the measurement report.

In one embodiment of the invention, it is envisaged that a Network Operator may decide to use existing planning techniques to continue to plan (and configure) the neighbour cell list for the macro network. In such an embodiment, it is envisaged that the Network Operator may use the ‘unplanned’ approach for all the femto neighbour cells and the ‘planned’ approach for all macro neighbour cells.

In one embodiment of the invention, it is envisaged that the global cell identity in the combined macro-cell/femto-cell system, using an unplanned entry in the neighbour cell list, will be of the same format as an entry in the neighbour cell list of the current 3GPP macro-cell neighbour cell list. Thus, the global cell identity may be made up of ‘12’ bits of an RNC identifier and ‘16’ bits of a cell identifier.

If the macro cell decides to initiate handover of the UE to an ‘unplanned’ cell, the RNC 236 sends a ‘Handover Required’ message to the core network that includes the Global Cell Identity of the identified unplanned neighbour cell (as contained in the measurement report from the UE and as illustrated in Table 1). Notably, for unplanned entries, the measurement report still contains the abstract index from the measurement control message and, in accordance with embodiments of the invention, additionally includes the global cell identifier of the unplanned cell.

As will be appreciated by a skilled artisan, the macro RNC knows the frequency, scrambling code and global cell identifier for all macro (planned) neighbours, as well as the frequency and scrambling codes for all femto (unplanned) neighbours. Thus, the macro RNC constructs and transmits a neighbour cell list containing both planned and unplanned neighbour cells. Table 1 shows an example of the neighbour cell list information known by the RNC, with the items in italics contained in the broadcast neighbour cell list.

TABLE 1

| Temporary Identifier | | | | |
|---|---|---|---|---|
| (Automatically | | Global | | Scrambling |
| allocated by the RNC) | Type | Cell ID | Frequency | Code |
| 1 | Planned | 123456 | F1 | SC11 |
| 2 | Planned | 56789 | F2 | SC27 |
| 3 | Unplanned | Unknown | F3 | SC33 |
| 4 | Unplanned | Unknown | F1 | SC50 |

As will be appreciated by a skilled artisan, handover from a femto cell to a macro cell is much less of a problem. Here, each femto cell will only have a small number of ‘adjacent’ macro cell neighbours. Hence, each macro cell neighbour will have a unique frequency and scrambling code. Based on this, handover from a femto cell to a macro cell will typically follow the 3GPP standard.

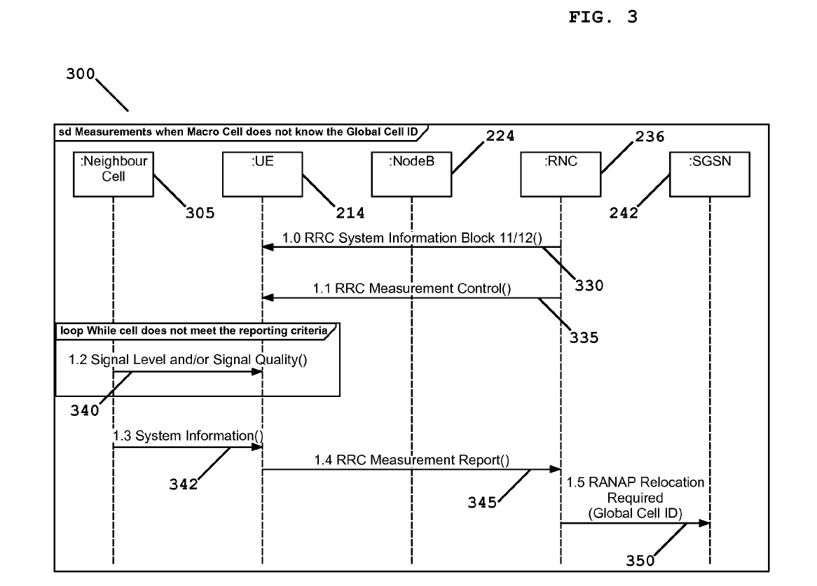

Referring now to FIG. 3 there is illustrated a message sequence chart 300 of a use of improved measurement reports in a cellular communication system that combines macro-cell and femto-cells, in accordance with an embodiment of the invention.

In the envisaged cellular communication system that combines macro-cell and femto-cells, the neighbour cell list is configured in the radio network controller (RNC) 236 of the macro-cell network. The RNC 236 also stores a neighbour cell list (in a memory element (not shown)) for each of the Node-Bs 224 that the RNC 236 controls. The neighbour cell list for each Node-B 224 (as configured at the RNC 236) is essentially still a list of structures; with each structure containing a frequency, scrambling code and global cell identifier of every neighbour cell 305, noting that the RNC 236 is only configured with the global cell identifier for the planned (macro) cells.

If we assume that an user equipment (UE) 214 is participating in an active call, the UE 214 is also receiving the neighbour cell list in a radio resource control (RRC) system information message 330 from the RNC 236. In step 330 and 335 the Macro Cell uses a combination of System Information messages (known in 3GPP as System Information blocks ‘11’ and ‘12’) to instruct the UE 214 of the identity of the macro and femto cells to monitor. The UE 214 uses the frequency and scrambling code contained therein to monitor and ultimately identify the best (generally closest) neighbour cell to consider as a potential handover cell. The messages 330, 335 also instruct the UE 214 as to what criteria should trigger the sending of a measurement report (e.g. a signal level and/or a signal quality exceeding a predetermined threshold) 345, and what information should be included in the measurement report. The messages 330, 335 assign each neighbour cell a temporary identifier that is used to refer to the cell in the corresponding measurement report 345.

The Measurement Control message instructs the UE 214 to include the Global Cell Identity of the identified and acceptable neighbour cell(s) in the measurement report. In step 340 the UE 214 monitors the specified neighbour cells 305, for example the signals routed via the NodeBs 224, as well as femto cell signals routed by APs 240, until one of them meets the specified criteria.

The UE 214 then monitors 340 the specified neighbour cells), identified in RRC measurement control message 335, until at least one of them meets the specified criteria. Once one of the neighbour cells meets the specified criteria, the UE 214 sends a Measurement Report to the RNC 236. When the UE 214 reports measurements for a neighbouring femto cell 305, the UE includes the corresponding global cell identifier from the system information message 130 that it receives. The Measurement Report 345 identifies the particular cell that meets the specified criteria using the temporary index provided by the RNC 236 in the messages 330, 335.

In step 342, the UE 214 retrieves the Global Cell Identity of the neighbour femto cell 305 by reading the System Information broadcast by the neighbour cell 305. In one embodiment of the invention, step 342 may be performed prior to step 340, as the UE only knows those cells to monitor once it has received the messages in steps 330 and 335.

In step 345, once one of the monitored neighbour cells meets the specified criteria, the UE 214 sends a Measurement Report. The Measurement Report contains the information requested in the original System message. Notably, in accordance with embodiments of the invention, the Measurement Report additionally identifies the global cell identifier of the cell that meets the criteria assigned in the Measurement Control and/or System Information messages 330, 335.

In step 350 based on the information in the Measurement Report, the RNC 236 determines whether to perform handover. If the RNC 236 decides that a handover is required it sends a Relocation Required message 350 to the MSC or SGSN 242 containing the Global Cell Identity of the target cell. For ‘unplanned’ cells, the RNC 236 uses the Global Cell Identity received in the Measurement Report; for ‘planned’ cells the RNC 236 uses the configured Global Cell Identity. Thereafter, the known handover process continues.

Although the above embodiment of the invention describes a use of an improved measurement report to facilitate handover between femto and macro cells, it is envisaged that the inventive concept is not restricted to such a handover embodiment.

It is envisaged that the aforementioned inventive concept aims to provide one or more of the following advantages:
(i) The inventive concept, in employing an improved measurement report, may be used to facilitate handover between a macro cell and a femto cell in a cellular communication system that supports communication over both cells.
(ii) The inventive concept does not require new 3GPP messages to be adopted, say in the 3GPP standard, as it re-uses existing 3GPP messages that are used to set up measurements, which advantageously already contain the IDs needed to instruct the UE to read and report global cell identifiers. Furthermore, the proposed use of existing 3GPP measurement reports utilises reports that already contains the IDs needed to report the global cell identifier.
(iii) The inventive concept only requires supporting functionality to be provided within an RNC and a UE.
(iv) The inventive concept does not require supporting functionality to be provided within the core network.

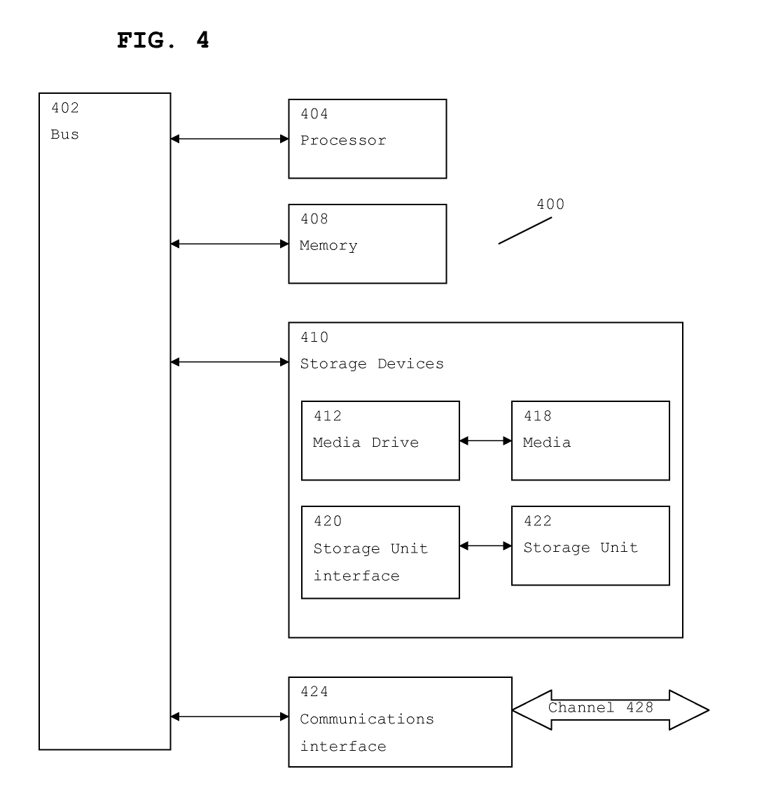

FIG. 4 illustrates a typical computing system 400 that may be employed to implement processing functionality in embodiments of the invention. Computing systems of this type may be used in Radio network controllers and UEs (in particular, processing logic in an RNC or UEs that handle neighbour cell list information and measurement reports). Those skilled in the relevant art will also recognize how to implement the invention using other computer systems or architectures. Computing system 400 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 400 can include one or more processors, such as a processor 404. Processor 404 can be implemented using a general or special-purpose processing engine such as, for example, a microprocessor, microcontroller or other control logic. In this example, processor 404 is connected to a bus 402 or other communications medium.

Computing system 400 can also include a main memory 408, such as random access memory (RAM) or other dynamic memory, for storing information and instructions to be executed by processor 404. Main memory 408 also may be used for storing temporary variables or other intermediate information during execution of instructions to be executed by processor 404. Computing system 400 may likewise include a read only memory (ROM) or other static storage device coupled to bus 402 for storing static information and instructions for processor 404.

The computing system 400 may also include information storage system 410, which may include, for example, a media drive 412 and a removable storage interface 420. The media drive 412 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive.

Storage media 418 may include, for example, a hard disk, floppy disk, magnetic tape, optical disk, CD or DVD, or other fixed or removable medium that is read by and written to by media drive 44. As these examples illustrate, the storage media 418 may include a computer-readable storage medium having particular computer software or data stored therein.

In alternative embodiments, information storage system 410 may include other similar components for allowing computer programs or other instructions or data to be loaded into computing system 400. Such components may include, for example, a removable storage unit 422 and an interface 420, such as a program cartridge and cartridge interface, a removable memory (for example, a flash memory or other removable memory module) and memory slot, and other removable storage units 422 and interfaces 420 that allow software and data to be transferred from the removable storage unit 418 to computing system 400.

Computing system 400 can also include a communications interface 424. Communications interface 424 can be used to allow software and data to be transferred between computing system 400 and external devices. Examples of communications interface 424 can include a modem, a network interface (such as an Ethernet or other NIC card), a communications port (such as for example, a universal serial bus (USB) port), a PCMCIA slot and card, etc. Software and data transferred via communications interface 424 are in the form of signals which can be electronic, electromagnetic, and optical or other signals capable of being received by communications interface 424. These signals are provided to communications interface 424 via a channel 428. This channel 428 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ ‘computer-readable medium’ and the like may be used generally to refer to media such as, for example, memory 408, storage device 418, or storage unit 422. These and other forms of computer-readable media may store one or more instructions for use by processor 404, to cause the processor to perform specified operations. Such instructions, generally referred to as ‘computer program code’ (which may be grouped in the form of computer programs or other groupings), when executed, enable the computing system 400 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 400 using, for example, removable storage drive 44, drive 412 or communications interface 424. The control logic (in this example, software instructions or computer program code), when executed by the processor 404, causes the processor 404 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors. Thus, the elements and components of an embodiment of the invention may be physically, functionally and logically implemented in any suitable way. Indeed, the functionality may be implemented in a single unit, in a plurality of units or as part of other functional units.

Although the invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, a method and apparatus for using measurement reports in a cellular communication system that combines macro-cell and femto-cells has been described, which substantially addresses at least some of the shortcomings of past and present techniques and/or mechanisms.

1. A network element for a cellular communication system, wherein the network element comprises:
a receiver for receiving a message from a wireless communication unit that comprises a measurement report; and
signal processing logic, operably coupled to the receiver, for processing the received measurement report and extracting a global cell identifier therefrom,
said global cell identifier being unique to a cell to which the received measurement report relates,
wherein the signal processing logic is further arranged to determine whether the network element has been configured to use the extracted global cell identifier and based thereon initiate handover of the wireless communication unit to the cell identified by the global cell identifier.

2. The network element of claim 1, wherein the cellular communication system supports communication over both macro-cells and femto-cells.

3. (canceled)

4. (canceled)

5. The network element of claim 1, wherein the signal processing logic is arranged to initiate handover of the wireless communication unit from a planned cell to an unplanned cell that is identified by the global cell identifier.

6. The network element of claim 5, wherein the unplanned cell is one of multiple femto cells that lie within a coverage area of a macro cell.

7. The network element of claim 1, wherein the signal processing logic is arranged to initiate handover of the wireless communication unit from a macro cell to a femto cell that is identified by the global cell identifier.

8. A method for employing measurement reports in a cellular communication system comprising, at a network element:
receiving a message from a wireless communication unit that comprises a measurement report;
processing the received measurement report and extracting a global cell identifier therefrom;
determining whether the network element has been configured to use the extracted global cell identifier; and
based thereon initiating handover of the wireless communication unit to a cell identified by the global cell identifier.

9. The method of claim 8, wherein the cellular communication system supports communication over both macro-cells and femto-cells.

10. (canceled)

11. (canceled)

12. The method for employing measurement reports of claim 8, wherein initiating handover comprises performing handover from a planned cell to an unplanned cell that is identified by the global cell identifier.

13. The method for employing measurement reports of claim 8, wherein initiating handover comprises performing handover from an unplanned cell that is one of multiple femto cells that lie within a coverage area of a macro cell.

14. The method for employing measurement reports of claim 8, wherein initiating handover comprises performing handover from a macro cell to a femto cell that is identified by the global cell identifier.

15. A wireless communication system adapted to support the network functions of claim 1.

16. A wireless communication unit for use in a cellular communication system, wherein the wireless communication unit comprises:
a receiver for receiving a first message from a network element requesting a measurement report from a neighbour cell;
a signal processing logic, operably coupled to the receiver, for processing a second message received from the neighbour cell, extracting a global cell identifier from the second message and producing a measurement report comprising the extracted global cell identifier; and
a transmitter for transmitting the measurement report to the network element;
wherein the signal processing logic is arranged to hand over communication to a cell identified by the global cell identifier based on the network element being configured to extract and use the global cell identifier from the measurement report.

17. The wireless communication unit of claim 16, wherein the cellular communication system supports communication over both macro-cells and femto-cells.

18. A computer-readable storage element having computer-readable code stored thereon for programming signal processing logic to perform a method for employing measurement reports in a cellular communication system, the computer-readable storage element comprising code for:
receiving a message from a wireless communication unit that comprises a measurement report;
processing the received measurement report and extracting a global cell identifier therefrom;
determining whether the network element has been configured to use the extracted global cell identifier; and
based thereon initiating handover of the wireless communication unit to a cell identified by the global cell identifier.

19. A computer-readable storage element having computer-readable code stored thereon for programming signal processing logic to perform a method for employing measurement reports in a cellular communication system, the computer-readable storage element comprising code for:
receiving a first message from a network element requesting a measurement report from a neighbour cell;
processing a second message received from the neighbour cell,
extracting a global cell identifier from the second message and producing a measurement report comprising the extracted global cell identifier; and
transmitting the measurement report to the network element.

20. (canceled)
